(19) United States
(12) Patent Application Publication
(10) Pub. No.: US 2023/0052983 A1
(43) Pub. Date: Feb. 16, 2023

(54) Waxing Composition and Method of Use

(71) Applicant: 3M INNOVATIVE PROPERTIES COMPANY, St. Paul, MN (US)

(72) Inventors: John A. Luekemeyer, Jurupa Valley, CA (US); Derrick Tarn, Santa Ana, CA (US); Blake T. Beamish, Costa Mesa, CA (US)

(21) Appl. No.: 17/792,640

(22) PCT Filed: Jan. 18, 2021
(86) PCT No.: PCT/IB2021/050354

§ 371 Date: Jul. 13, 2022

Related U.S. Application Data
(60) Provisional application No. 62/965,017, filed on Jan. 23, 2020.

(51) Int. Cl. C11D 11/00; C11D 3/37

(52) U.S. Cl. CPC C11D 11/0041; C11D 3/373

(57) ABSTRACT

A waxing composition configured to be used in combination with an aqueous washing composition, and methods of concurrently washing and waxing a surface using the waxing composition and the aqueous washing composition in combination. The waxing composition includes at least one hydrophobic film-forming material, wherein the waxing composition present in a non-stabilized hydrophobic phase that is different from the washing composition.

### BACKGROUND

Surfaces of e.g. motor vehicles and the like are frequently washed and/or waxed in order to remove dirt, grime and so on, and to impart a glossy appearance to the surface.

### SUMMARY

In broad summary, herein is disclosed a waxing composition configured to be used in combination with an aqueous washing composition, and methods of concurrently washing and waxing a surface using the waxing composition and the aqueous washing composition in combination. The waxing composition comprises at least one hydrophobic, film-forming material. The aqueous washing composition comprises at least one surfactant. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a perspective view of an exemplary arrangement in which a washing implement bears a first, aqueous washing composition and a second, waxing composition.

FIG. 2 is a side perspective view of an exemplary arrangement in which a container holds a first, aqueous washing composition and a second, waxing composition that is present as a layer atop the first, washing composition.

FIG. 3 is a side view of a washing implement in the process of being inserted into a container comprising a first, aqueous washing composition and a second, waxing composition that is present as a layer atop the first, washing composition.

FIG. 4 is a perspective view of an exemplary washing implement in the form of a washing mitt.

FIG. 5 is a cross-sectional view of the exemplary washing mitt of FIG. 3.

FIG. 6 is a Working Example photograph of a surface of a motor vehicle that was subjected to washing/waxing operations as discussed later herein.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings are not to scale and are chosen for the purpose of illustrating different embodiments of the invention. In particular the dimensions of the various components are depicted in illustrative terms only, and no relationship between the dimensions of the various components should be inferred from the drawings, unless so indicated. Terms such as “top”, “bottom”, “upper”, “lower”, “under”, and “over” have their customary meaning in regard to items positioned for their ordinary use. The term “configured to” and like terms is at least as restrictive as the term “adapted to”, and requires actual design intention to perform the specified function rather than mere capability of performing such a function. All references herein to numerical values (e.g., dimensions, ratios, and so on), unless otherwise noted, are understood to be calculable as average values derived from an appropriate number of measurements of the parameter(s) in question.

### DETAILED DESCRIPTION

Terms such as “waxing”, “waxed”, and the like, are used in accordance with their colloquial use denoting a process of forming of a hydrophobic protective film on the surface of an entity (e.g., a motor vehicle). Such terminology does not require that the hydrophobic film must necessarily include a wax (e.g., carnauba wax) according to chemical composition. Rather, a hydrophobic film formed by “waxing” may for comprise, or consist of, silicone materials for example. However, the term “wax”, when used herein as a noun, does specifically denote a material that is a wax according to the chemical composition and structure of the material, as discussed in detail later herein.

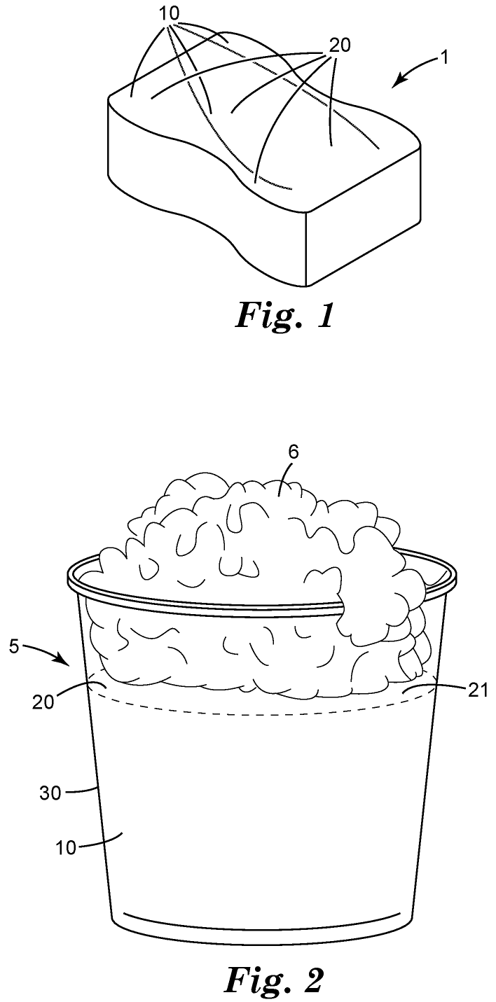

Disclosed herein is a method of concurrently washing and waxing a surface, e.g., of a vehicle such as an automobile. With reference to FIG. 1, the method comprises manually contacting a washing implement 1 with the surface and moving the washing implement about the surface. By manually is meant that the washing implement is held by a user’s hand (or worn on a user’s hand) and is moved about the surface by hand, without the use of any motorized or automated equipment.

The washing implement bears a first, washing composition 10 that is present in a first, aqueous phase and that is an aqueous composition (e.g., comprising at least 60, 80, or 90 wt.% water) comprising at least one surfactant. The washing implement also bears a second, waxing composition 20 at least a majority of which is present in a second, hydrophobic phase that is different from the first, aqueous phase. The second, waxing composition 20 is a hydrophobic, film-forming composition comprising at least one hydrophobic, film-forming material. Moving the washing implement about the surface causes the washing composition/phase 10, and the waxing composition/phase 20, to be brought into contact with the surface. This enables portions of the washing implement that bear the washing composition to clean the surface (e.g., to remove dirt, debris, grime, and so on therefrom) and enables portions of the washing implement that bear the waxing composition to “wax” the surface, i.e., to deposit material thereon that forms a hydrophobic, protective film on the surface.

### Concurrent Washing/Waxing

The arrangements disclosed herein allow the washing and waxing operations to be performed concurrently. By this is meant that washing and waxing operations do not have to be performed in a sequential manner in which the surface is washed with a first, washing composition after which a second, waxing composition, prepared separately by the user, is used to perform the waxing. In other words, a concurrent washing/waxing procedure as described herein differs from customary approaches in which separate, sequential washing and waxing operations are performed using separate washing and waxing compositions. In particular, the presently-disclosed arrangements do not require a drying period between washing and waxing operations. In some embodiments, the presently-disclosed arrangements may not require any additional step such as a (e.g., a drying or buffing step) after the concurrent washing and waxing operation (the surface may of course be rinsed after the concurrent washing and waxing, as discussed later herein).

The arrangements disclosed herein enable, for example, a “one-bucket” mode of operation in which washing and waxing are performed using a single, common container that contains the first, washing composition and the second, waxing composition, and into which a washing implement 1 can be inserted into the container so as to imbibe both compositions, after which the washing implement is contacted with a surface to perform both washing and waxing.

Those of ordinary skill in the use of washing and waxing compositions will appreciate that the art is replete with instances in which it is asserted that “simultaneous” washing and waxing of surfaces can be performed. However, the performance of simultaneous washing and waxing has been limited by the fact that these operations are essentially working at cross purposes. That is, the goal of a washing composition is to remove dirt, grime, grease and so on from a surface. Typically, the washing composition is an aqueous composition that uses one or more surfactants for this purpose. The goal of a waxing composition is to deposit a layer of protective, hydrophobic film-forming material on the surface (e.g., so that the surface becomes glossy and so that water beads up and runs off the surface). These goals are essentially at odds. That is, the surfactant may sequester the hydrophobic film-forming material into surfactant-stabilized parcels (e.g., micelles) thus preventing much of the film-forming material from being deposited onto the surface. Conversely, the hydrophobic film-forming material may deplete much of the surfactant into forming such surfactant-stabilized parcels, thus less surfactant may be available to interact with dirt on the surface so that the dirt can be removed. Thus, although some arrangements may have been achieved in the art that enable the performing of simultaneous washing and waxing, typically each operation is not performed to the maximum extent possible. For example, such operations may not render a surface as clean, and/or as hydrophobic, as might be achieved by performing separate, sequential washing and waxing operations.

The arrangements disclosed herein can allow washing and waxing operations to be performed concurrently (e.g., in a one-bucket mode of operation), while enabling either, or both, operations to be performed to a more complete extent than previously achieved. In particular, such arrangements may enhance the hydrophobicity of the washed/waxed surface that is achieved, in comparison to “simultaneous” washing/waxing approaches found in the art.

The present results are achieved by going against conventional approaches to simultaneous washing/waxing operations, in which a waxing composition is stably dispersed (typically, is stably emulsified) into a washing composition, e.g., to promote shelf life and appearance. Rather, in the present approach a first, washing composition 10 and a second, waxing composition 20 are maintained as first and second separate phases, that are both brought into contact with the surface to be cleaned and waxed. In many embodiments, this is performed by disposing the first and second phases on a common washing implement 1 so that both phases are brought into contact with the surface at various times and at various locations of the surface, as the washing implement is moved about the surface. In contrast to approaches in which a waxing composition is present as a second phase that is, e.g., a stable dispersion or emulsion, in the herein-disclosed approach the waxing composition is present in a second phase that is a non-stabilized phase as defined and discussed later herein.

The present work has demonstrated that such an approach can allow an effective amount of a second, waxing phase/composition to be deposited onto a surface to enable a readily observable, long-lasting hydrophobic protective film to be formed thereon, as demonstrated by FIG. 6 and as discussed in detail in the Examples herein. Moreover, the waxing composition is configured so that it does not unduly deplete the surfactant available in an active form to perform washing; for example, the washing composition may still exhibit abundant suds, as discussed elsewhere herein.

### Washing/Waxing Assemblage

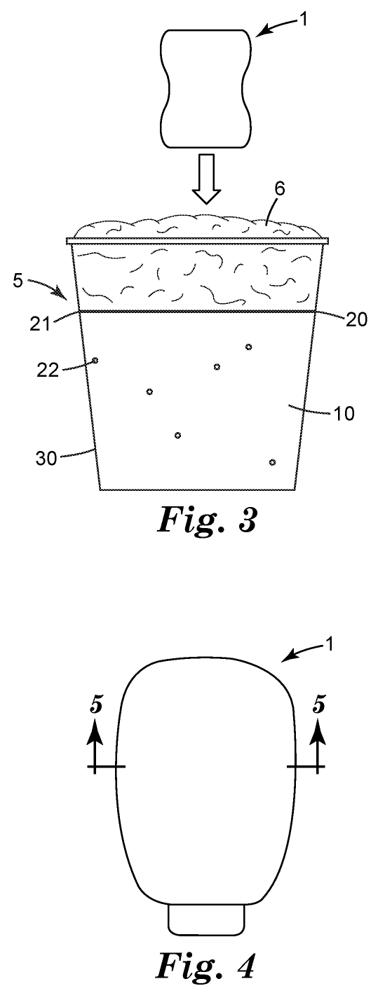

As discussed above, the arrangements disclosed herein rely on contacting a surface with a washing implement 1 that bears a first, washing composition 10 in a first, aqueous phase, and a second, waxing composition 20 in a second, hydrophobic phase. One exemplary way in which this can be achieved is depicted in FIGS. 2 and 3. FIG. 2 depicts a container 30 (e.g., a bucket, such as, e.g., a 2, 3, 4 or 5 gallon bucket, which is a convenient size for manual washing of a motor vehicle) comprising a washing/waxing assemblage 5. The term “assemblage” is used rather than the term “mixture”, since the washing and waxing phases are typically not intimately or thoroughly mixed together and in many cases measures may be taken to minimize any such mixing, as this disclosure makes clear.

Washing/waxing assemblage 5 comprises a first, washing composition 10 that is an aqueous composition and that is present as a first phase. Often, this first, aqueous phase may be present in container 30 as a continuous phase, although it may become fragmented or otherwise dissociated into individual parcels when imbibed onto a washing implement. Washing/waxing assemblage 5 also comprises a second, waxing composition 20 that is a hydrophobic, film-forming composition comprising at least one hydrophobic, film-forming material. Second, waxing composition 20 is present as a second, hydrophobic phase that is different from the first, aqueous phase. In many embodiments, while the first and second phases are in container 30 at least a portion of this second phase 20 may take the form of a surface layer 21 that is present atop the first, aqueous phase 10, as shown in exemplary manner in FIG. 2.

In such an approach, a washing implement 1 may be inserted (e.g., downward) into the interior of container 30 so that it is at least partially, or completely, immersed in the first, washing composition/phase 10, as indicated in the exemplary depiction of FIG. 3. In doing so, at least a portion of washing implement 1 may contact and/or pass through the surface layer 21 of waxing composition/phase 20, either on the way downward into washing phase 10 and/or on the return journey upward out of container 30. This can cause at least a portion of waxing composition/phase 20 to be imbibed onto washing implement 1.

Washing implement 1, having been inserted into and removed from container 1, will thus bear first and second phases of washing composition 10 and waxing composition 20, for application to a surface in the general manner described above. The first and second phases may be present as parcels (e.g., droplets, globules, smears, etc.) that are scattered over the length and breadth of the washing implement in quasi-random fashion. It will be understood that the first and second phases may not necessarily be visible on the washing implement to the unaided human eye. That is, such phases may be rather small and/or may not be visually distinguishable to the unaided eye against a fibrous or otherwise irregular background of a washing implement.

One convenient way in which the above arrangements can be achieved is by the addition of a waxing composition to a washing composition in a prescribed manner. For example, a washing composition 20 can be formed, e.g., by the deposition of water and a washing concentrate (comprising one or more surfactants and, e.g., various ancillary additives as discussed in detail later herein) into a container 30. Such a process may be carried out in any manner and in any order; e.g., by adding the washing concentrate to the container and subsequently adding water, or vice versa. As will be well understood, such a process as carried out by a user, typically involves aggressively mixing the washing concentrate and the water. This may be done, e.g., by, at least during the later stages of adding water to an aqueous mixture in which at least some of the washing concentrate is already present, spraying the water into the container as a high-velocity spray that roils the water to form a highly sudsed mixture (that is, a mixture with a large amount of suds 6 visible above the upper surface of the water, as in FIGS. 2 and 3). This is often done because of a user perception that a large amount of visible suds is associated with more effective washing.

### Non-Stabilized Waxing Composition

Thus, by whatever specific procedure, a user may at least partially fill a container 30 with a first, aqueous washing composition 10. To this composition 10 can be added a second, waxing composition 20. The waxing composition can take any form as long as it can be added in such a manner that will dispose/retain a majority of the waxing composition in the form of a second, non-stabilized hydrophobic phase (e.g., a surface layer 21) that is available to be deposited onto a washing implement and from there to be applied to a surface.

By a non-stabilized hydrophobic phase is meant a hydrophobic phase that is not in the form of a stable dispersion within a first, aqueous phase. By definition, a non-stabilized hydrophobic phase is distinguished from a hydrophobic phase that is in the form of surfactant-stabilized parcels. Thus, surfactant-stabilized micelles, emulsions such as microemulsions (e.g., that are thermodynamically stable), macroemulsions (e.g., that are kinetically stable), and the like, fall outside the definition of a non-stabilized hydrophobic phase. Moreover, any dispersion of a hydrophobic phase in an aqueous phase that is characterized as “stable” (even if the stability is not necessarily achieved by the use of a surfactant), will not qualify as being a non-stabilized hydrophobic phase as defined herein. (In fact, any such dispersion that, even if not explicitly characterized as stable, is nevertheless described in such terms that make it clear that the dispersion, as made, can be packaged, shipped, stored, and so on, would be understood by an ordinary artisan as being a stable dispersion, and falls outside the definition of a non-stabilized hydrophobic phase.)

Thus for example, stable dispersions of the general type described in U.S. Pats. 7,541,323 and 7,378,382 (in which stable dispersions are achieved, apparently without requiring the use of surfactants) are not considered to comprise a non-stabilized hydrophobic phase as disclosed herein. Other dispersions, emulsions, and so on, that are not considered to comprise a non-stabilized hydrophobic phase as disclosed herein, include those disclosed, e.g., in U.S. Pats. 5518533, 6475934, 6506715, and 8349062.

In various embodiments, the production of a washing/waxing assemblage comprising a first, aqueous phase and a second, hydrophobic phase that is non-stabilized may be achieved by selection of the materials of the waxing composition and/or the materials of the washing concentrate, and/or by selection of the method by which the waxing composition, the washing concentrate, and water, are brought together to form the washing/waxing assemblage, as discussed herein. In many embodiments a second, hydrophobic, non-stabilized phase of such an assemblage (while in a container such as a bucket) may be present as a macroscopic phase, e.g., as a layer atop the first, aqueous phase. Such an assemblage may be identified as having a second, hydrophobic phase that is non-stabilized if, for example, the two phases, having been momentarily intermixed, e.g., by manual shaking, soon (e.g., within a few minutes) form two macroscopic phases (e.g., the second, hydrophobic phase forms or re-forms as surface layer atop the first, aqueous phase). Conversely, a mixture that comprises a second, hydrophobic phase that remains as an unchanging dispersion for an extended period (e.g., that remains stable for an hour) would be considered to have a second, hydrophobic phase that is stabilized rather than non-stabilized.

It will be appreciated that it may not be necessary that the entirety of the waxing composition must be present as a non-stabilized second phase. All that is needed is that a useful percentage of the waxing composition is in the form of a non-stabilized second phase so that it is easily transferrable onto a washing implement and from there to a surface to be washed/waxed. In other words, in some embodiments it is acceptable for, e.g., a relatively small percentage of the waxing composition to be present as surfactant-stabilized droplets 22 that are, e.g., dispersed throughout the first, washing phase 10 rather than being, e.g., in a non-stabilized surface layer 21, as shown in exemplary embodiment in FIG. 3. Thus in various embodiments, a washing/waxing assemblage and/or methods of handling and using the assemblage may be configured so that more than 50, 60, 70, 80, 90, 95, or 98 wt.% of the waxing composition will be in the form of a non-stabilized second phase. In various embodiments, these conditions may hold when the washing/waxing assemblage is first formulated (e.g., in a common container or bucket), and/or may hold when the phases are present on a washing implement onto which they have been imbibed.

The above discussions make it evident that in some embodiments, it may be helpful that the washing composition 10 and the waxing composition 20 should not be mixed together or otherwise processed in such a manner that causes the waxing composition to be stably dispersed into droplets (e.g., emulsified into surfactant-stabilized droplets) rather than remaining as a second, non-stabilized phase. Thus in some embodiments, high-shear mixing of the waxing composition with the first, aqueous washing phase may be minimized or avoided. Rather, in some instances the waxing composition may be added to the first, aqueous washing phase in a relatively gentle, low shear manner. In this context, low shear (and equivalently, the absence of high-shear), means that the process is carried out without agitation by any motorized impeller and without visible frothing, roiling, formation of vortices, and so on.) In some embodiments, this may be achieved by pouring the waxing composition into the container so that the waxing composition remains on (and/or blooms to) top of the first, aqueous washing composition as a layer 21, e.g., to form an arrangement of the general type depicted in FIGS. 2 and 3. (If a layer of suds 6 is present, the waxing composition may pass through a portion of the suds layer on its way downward into the container.) In some such embodiments, avoiding the performing of any operation (such as, e.g., jetting a high-velocity spray of water into the washing/waxing assemblage) that will roil or froth the liquids may enhance the ability of the waxing composition to form a surface layer; however, this may not be necessary in all cases, as discussed herein.

### Packaging the Waxing Composition

A waxing composition may be provided to an end user in various ways to achieve the ends desired herein. For example, in some embodiments a waxing composition may be provided in one or more premeasured, e.g., prepackaged, quantities (e.g., 7.5 grams, 15 grams, 30 grams, etc.) that are suitable for being added to, e.g., two or three gallons of water in a bucket. In other embodiments, a waxing composition may be provided in a “bulk” container from which a desired amount may be dispensed, e.g., into a bucket. For example, a waxing composition may be provided in a bottle, e.g., with the cap of the bottle being sized and/or provided with indicia to enable a particular amount of the waxing composition to be meted out.

The above-described arrangements may be convenient in many circumstances. However, the waxing composition need not necessarily be added to a container prior to the addition of any water and/or washing concentrate, as long as sufficient measures are taken to prevent, e.g., emulsification of the waxing composition into a stable dispersion when, and after, the water is added. Thus for example, in some embodiments a waxing composition may be packaged inside a pouch or sachet that is made of a suitable material, e.g., an organic polymeric material that is water-soluble. The characteristics of the pouch material may be chosen so that the material is dissolved by water at a suitable rate (at the temperatures typically used in washing of surfaces, e.g., 60-80 degrees F in many instances). This may allow, for example, that the pouch can be inserted in a bucket of water and a washing concentrate may be added and the water agitated to form washing composition 10, after which the pouch will open to release the waxing composition so that it can e.g. float to the top of the water phase.

The properties of the pouch material may be selected so that, for example, the pouch does not dissolve too soon, but so that the user does not have to wait too long before using the washing/waxing assemblage. For example, the pouch material may be configured so that the pouch material dissolves sufficiently to release the waxing composition in a few (e.g. 1-5) minutes. A conveniently suitable water-soluble organic polymeric material for such a pouch may be, for example, polyvinyl alcohol (PVA) and like substances. The structure of such a PVA (e.g. the degree of transesterification from the source polyvinyl acetate, the molecular weight, etc.) may be varied so as to cause the material to dissolve in an appropriate time frame.

If desired, in some embodiments a washing concentrate may similarly be packaged in a water-soluble pouch; if desired, such a pouch may be configured to dissolve so as to release its contents more rapidly than a pouch that packages a waxing composition. Thus in some embodiments two such pouches may be added to a bucket (before or after the addition of water). Or, a single pouch with first and second compartments may be used. (If desired, one or both of the compartments may be e.g. coated or otherwise treated so that the two compartments differ in their water-solubility e.g. so that the waxing composition is released later than the washing concentrate.) However, in many convenient embodiments a washing concentrate may be e.g. added to a bucket in a premeasured/prepackaged amount, or dispensed in a desired amount from a bulk container, in similar manner described as described above with regard to the waxing composition.

An advantage of at least some herein-described embodiments results when the waxing composition is configured to form a layer atop the aqueous, washing phase rather than to be dispersed throughout the entire volume of the washing phase. Specifically, the amount of waxing composition to be added may be chosen according to the area of the top surface of the washing phase rather than according to the volume of the washing phase. This allows the amount of waxing composition to be used to be less dependent on the total volume of washing phase that is used. Put another way, a two-gallon volume of washing phase will exhibit a similar upper surface area to that of a three-gallon volume of washing phase, when held in a conventional washing bucket. Thus, the amount of waxing composition to be used can be chosen according to rather simple guidelines.

Moreover, the fact that the washing composition and the waxing composition are provided in separate, independent phases, means that in some instances each phase may be manipulated independently. That is, running out of one phase does not necessarily mean that the entire washing/waxing assemblage must be discarded and the user forced to make up a new washing/waxing assemblage. For example, if it becomes apparent that the waxing composition has been depleted (e.g., if a surface that is washed does not exhibit the usual degree of hydrophobicity), but the washing composition is present in sufficient volume and appears to still be effective, an additional amount of waxing composition may simply be added to the washing/waxing assemblage to replenish the surface layer of waxing composition. Conversely, if it appears that the surfactant has been depleted from the washing composition, additional surfactant may be added e.g. by adding additional washing concentrate. (Of course, this may be done so as to minimize any emulsifying of the waxing composition, as discussed in detail herein.) Still further, if the total volume of washing composition is less than desired, make-up water and/or washing concentrate may be added (e.g. in such manner as to minimize the transformation of any of the waxing composition into a stable emulsion).

The above discussions reveal another feature of the herein-disclosed arrangements. Specifically, a herein-disclosed waxing composition is used in a different manner from many waxing compositions of the art. Many such waxing compositions of the art are provided to a user as a concentrate; that is, with the active ingredients of the composition present in a concentrated form that is to be diluted and mixed (e.g. emulsified) throughout the entire volume of a washing composition so that the active ingredients are present in the final washing/waxing mixture in a form that is substantially diluted from their original form. In contrast, in at least some embodiments, the herein-disclosed waxing composition may merely spread to form a layer atop the washing composition (to form an assemblage, as described earlier herein) rather than being dispersed throughout the entire volume of the washing composition e.g. as an emulsion. In other words, the herein-disclosed washing composition is not a concentrate that is to be substantially diluted into an aqueous mixture, and is thus distinguished from various waxing concentrates as disclosed in the art.

In various embodiments, a waxing composition as disclosed herein may be configured to be combined with a washing composition (e.g. in a bucket) at a ratio of at least 1.0, 2, 3, 4, 5, 6, 7, 8, 9, 10, 12, 14, 16, 18 or 20 grams of waxing composition per gallon of washing composition. In further embodiments, a waxing composition may be configured to be combined at a ratio of less than 25, 19, 17, 15, 13, 11, 9.5, 8.5, 7.5, 6.5, 5.5, 4.5, 3.5, 2.5, or 1.5 grams of washing composition per gallon of washing composition. In various embodiments, the ratio of the waxing composition to the washing composition may be at least 0.02, 0.04, 0.08, or 0.16 wt.%; in further embodiments, the ratio of the waxing composition to the washing composition may be at most 2.0, 1.5, 1.0, 0.5, or 0.3 wt.%.

As a general guideline, the present work has indicated that adding a lower-than-optimum amount of waxing composition may not necessarily cause insufficient hydrophobicity of a washed surface to immediately result; rather, the supply of waxing composition may simply be exhausted more quickly. On the other hand, it has been found that a higher-than-optimum level of waxing composition has occasionally been found to impart an oily or greasy condition to the washed/waxed surface. Thus in some embodiments a user may be instructed to e.g. start with a relatively low level of waxing composition and to add additional waxing composition to the washing/waxing assemblage as needed. Of course, the optimum level of waxing composition may depend in part on the actual composition of the waxing composition; it may also depend at least somewhat on the particular washing composition with which it is used.

### Washing Implement

Any suitable washing implement 1 may be used for the purposes herein. In various embodiments, such a washing implement may take the form of e.g. a cloth or rag, a sponge, or the like. Any such implement by definition will be used manually. However, the surface-contacting portion of the implement does not necessarily have to be held directly by the user. For example, a washing implement may take the form of a sponge or foam that is connected to a handle that is held by a user (such implements often take the form of a squeegee that comprises a handle with one end comprising an elongated sponge and an oppositely-facing elongated rubber blade). In some embodiments, the washing implement may be held by the user; in other embodiments, the washing implement may take the form of a “mitt” 1 of the general type shown in FIG. 4. Such a mitt may have a hollow interior into which the user can insert his or her hand.

The washing implement may be made of any suitable material, processed in any suitable form. In some embodiments, the material may be fibrous, e.g. it may take the form of a woven textile, a nonwoven web, and so on. In some embodiments, the material may comprise, or take the form of, microfibers, e.g. having an average diameter of less than 10 microns.

The material of the washing implement (e.g., of at least the surface portion of the implement that will contact the surface to be washed and waxed) may be chosen to exhibit any suitable properties. For example, in various embodiments, the washing implement may comprise a material that is hydrophobic, a material that is hydrophilic, or mixtures, blends or combinations thereof. Examples of hydrophobic materials include many microfiber cloths comprised of e.g. polypropylene, polyester, or nylon. Examples of hydrophilic materials include cellulosic cloths and sponges, and the like. Any such material may be used; however, the present work has indicated that a hydrophobic material may exhibit a slightly enhanced ability to deposit the waxing composition on a surface, while a hydrophilic material may exhibit a slightly enhanced ability to perform washing of the surface. Thus, in some embodiments at least the surface-contacting portion of a washing implement may be configured to exhibit a desired property, e.g. an intermediate degree of hydrophobicity/hydrophilicity.

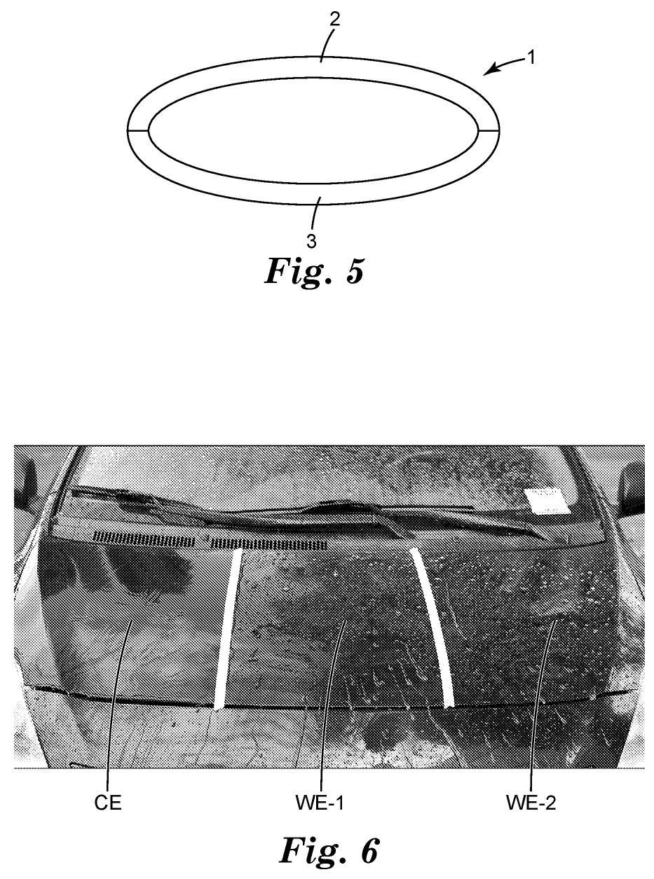

In some embodiments the washing implement may be asymmetric. For example, a “mitt” 1 of the type shown in FIG. 5 may comprise one major side and/or surface 2 that is relatively hydrophilic (comprising e.g. cellulosic fibers such as e.g. cotton fibers). The mitt may further comprise another, e.g. opposing, major side and/or surface 3, that is relatively hydrophobic in comparison to the hydrophilic side/surface. The mitt may be immersed into the washing/waxing assemblage, after which the hydrophilic side 2 may be used for washing strokes, and the hydrophobic side may be used for waxing strokes. (The waxing strokes may or may not be preceded by re-immersing the mitt into the washing/waxing assemblage.) In some embodiments, the hydrophilic side of the washing implement (e.g., mitt) may be comprised of materials (e.g., in the form of fibers) such as cotton or polyamide, while the hydrophilic side of the washing implement may be comprised of fibers of e.g. polyester. Recognizing that polyamides and polyesters embrace a number of variations, in each case the particular composition can be chosen for the property in question. For example, a polyamide can be chosen that is generally hydrophilic (such as e.g. Nylon 6 or Nylon 6,6), while a polyester may be chosen that is generally hydrophobic (e.g., poly(ethylene terephthalate)). In some embodiments, blends of mixtures of such materials may be used, with the ratio of components being chosen to provide the desired hydrophobicity or hydrophilicity. For example, in some embodiments the hydrophobic side of the washing implement may have at least 80, 90, or essentially 100 wt.% polyester (with the balance, if present, being polyamide), while the hydrophilic side may have from 15 or 25, to 45 or 35 wt.% polyamide (with the balance being e.g. polyester). In particular embodiments an asymmetric washing mitt may have a hydrophobic side that is essentially 100 wt.% polyester (e.g. PET), and a hydrophilic side that is a blend of 25-35 wt.% polyamide (e.g. Nylon 6 or Nylon 6,6) and 65-75 wt.% polyester (e.g. PET).

It is emphasized that such arrangements have been found to enhance the ability to perform washing and waxing; however, they are not necessary in order to achieve this ability. That is, if the arrangements disclosed herein are followed, any such washing implement will typically bear both a first, washing composition and a second, waxing composition and will be able to bring at least a portion of each composition into contact with a desired surface to be washed/waxed.

Similar effects may be achieved e.g. by using a first washing implement that is relatively hydrophilic for “washing” strokes and a second washing implement that is relatively hydrophobic for “waxing” strokes. It is emphasized that such arrangements still rely on the use of a single washing/waxing composition (contained e.g. in a single, common bucket) and thus fall within the overall concept of performing “concurrent” washing and waxing. However, in many convenient embodiments a single, common washing implement may be used (whether such an implement is symmetric or is asymmetric with e.g. hydrophilic and hydrophobic major sides).

Although the above-described arrangements may be particularly convenient in some circumstances, the discussions herein make it apparent that other methods of providing a washing implement with a first, washing composition that is present in a first, aqueous phase and a second, waxing composition that is present in a second, non-stabilized hydrophobic phase, are encompassed within the present disclosures. For example, in some embodiments a waxing composition may be provided to a user in a configuration in which it can be poured onto (or spritzed onto, or otherwise disposed on) a washing implement before or after the implement is immersed in a washing composition. In other embodiments, a washing implement may be provided to an end user with a waxing composition having been preimpregnated onto the washing implement e.g. at the factory (e.g. with the washing implement being packaged in such manner as to retain the waxing composition in place on the washing implement). A user may then immerse the washing implement in a washing composition (after removing the implement from its packaging if necessary) and then perform the washing/waxing as described herein. In still other embodiments, a waxing composition might be poured, spritzed, or otherwise deposited on a surface, after which a washing implement bearing a washing composition (e.g. a sudsy mitt) may be contacted with the waxing composition and then moved about the surface. In the process, the waxing composition may be gathered onto the implement and then redistributed about the surface.

All such approaches are encompassed within the broad disclosures contained herein. It will thus be clear that the waxing compositions disclosed herein (and methods of distributing such waxing compositions about a surface by way of a washing implement bearing the waxing composition and a washing composition) are not necessarily limited to approaches in which the waxing composition is formed into a layer atop a wash composition, in a container.

The contacting of a washing implement with a surface in the manner disclosed herein will remove at least some dust, dirt, debris, grime, or the like from the surface, and will also deposit at least some of the waxing composition on the surface. The subsequent evaporation of any remaining water from the washing composition (in some embodiments, along with any removal of any non-permanent component from the waxing composition), will result in the hydrophobic, film-forming material of the waxing composition forming a hydrophobic, protective film on the surface.

In some embodiments, the film-forming material may form a film purely by “physical” means, e.g. by processes that do not involve the formation of covalent chemical bonds between any constituents of the film-forming material. In some embodiments, the film-forming process may involve at least some formation of chemical bonds between at least some constituents of the film-forming material (for example, the film-forming material may comprise reactive silicone resins that may condense with each other, as discussed in detail later herein). In some embodiments (whether or not the film solidification occurs strictly by physical means or by some combination of physical solidification and formation of chemical bonds) the waxing composition may not comprise any constituents that form chemical bonds to the surface that is being washed/waxed. In other embodiments, the waxing composition may comprise one or more components (e.g. polydimethylsiloxanes that are functionalized to comprise reactive groups such as e.g. amino groups, as discussed in detail later herein) that are configured to react and form bonds with the surface. In some embodiments, any such reactive constituent of the waxing composition may be configured only to react with the surface, and to not react with any other component of the waxing composition.

If desired, the washed/waxed surface may be rinsed with water (typically, water not containing any surfactant, washing concentrate, etc.). It has been found that a surface that has been concurrently washed and waxed as disclosed herein may be rinsed with water very soon after the washing/waxing process has been performed. That is, it is not necessary to wait an extended period (e.g. tens of minutes or more) for the protective film to fully form before rinsing the surface. However, for optimum results it may be beneficial to not wash any particular area of the surface immediately (e.g. a few seconds) after washing/waxing that area. In other words, in some instances it may be beneficial to wait until an entire vehicle has been washed/waxed and then rinse the entire vehicle. This imparts no disadvantages and in fact is common practice when manually washing a vehicle. It may also be beneficial to apply the rinse water as a gentle stream rather than as a high-pressure jet, to avoid mechanically dislodging any of the protective-film, as will be well understood. (Of course, a pre-wash may be performed with e.g. a jet of water in order to remove gross debris, leaves, clods, and the like, before beginning the actual washing/waxing process with the washing implement, as is common practice when washing and waxing vehicles.)

### Waxing Composition

A waxing composition 20 is a hydrophobic, film-forming composition comprising at least one hydrophobic, film-forming material. By a film-forming composition is meant a composition that, after being applied to a surface and processed suitably (e.g. dried), forms a stable, protective, hydrophobic film on the surface. As noted earlier, in various embodiments the process of forming the film may occur e.g. solely by physical processes (e.g. by coagulation, solidification, etc., e.g. as liquid constituents are removed) or by a combination of physical processes and chemical processes that involve formation of covalent bonds). A waxing composition 20 will thus comprise at least one film-forming material, optionally along with any other ancillary components as are discussed in detail later herein.

A film-forming material may comprise any single material or combination, blend, mixture, etc. of materials, that is capable of forming a hydrophobic film under deposition conditions of the general type disclosed herein. In some embodiments, such a material may take the form of an actual “wax” as defined in terms of the chemical composition and properties of the material. In this particular instance the term “wax” denotes hydrophobic organic polymeric compounds such as e.g. a long chain aliphatic hydrocarbons, esters and diesters, fatty alcohols, and so on. Such waxes will often exhibit an intermediate molecular weight (e.g. in the range of 300 to 2500 grams per mole, on average) that is higher than that of small molecules (e.g. liquids and gases), but lower than that of polymeric materials such as e.g. polyethylene and the like. Such waxes may be e.g. synthetic, e.g. obtained by oligomerization of a suitable monomer (such as e.g. ethylene) to a suitable intermediate molecular weight. In some embodiments, such waxes may be obtained from plant or animal sources.

Potentially suitable waxes include e.g. paraffin waxes and microcrystalline waxes (derived e.g. from petroleum), montan wax (derived e.g. from coal), animal waxes such as beeswax or shellac wax (obtained from certain insects), and plant waxes such as soy wax, tallow tree wax, castor wax, bayberry wax, and so on. In particular embodiments, such a wax may be carnauba wax, which is obtained from leaves of a particular palm tree and may be particularly suited for use as a film-forming material for the present purposes.

Many such waxes will rely purely on physical methods of film formation. However, in some embodiments a film-forming material may comprise one or more materials of the general type known as drying oils. Such materials may include e.g. linseed oil, urushiol lacquers, and materials of this general type. In some embodiments a film-forming composition may take the form of an acrylic resin, e.g. dissolved in a suitable organic solvent. Acrylic resins include various materials such as poly(methylmethacrylate) and related compounds that result from the polymerization of (meth)acrylate monomers. In various embodiments, an acrylic resin may be film-forming purely by physical processes resulting e.g. from removal of solvent; or, such an acrylic resin may comprise reactive groups that allow at least some crosslinking of the polymer chains to occur in the course of film formation. An acrylic resin, if present, can be used in any suitable amount. However, in some embodiments the film-forming material of the waxing composition will comprise less than 5, 3, 1, 0.5, 0.2, 0.1, 0.05, or 0.01 wt.% of any acrylic resin.

In some embodiments a film-forming material may comprise one or more silicone materials. The term silicone material is used in general to refer to a large class of materials that are based on chains and/or networks of Si—O units. In some embodiments, such a silicone material may include, or be, a silicone liquid that is e.g. polydimethylsiloxane (PDMS) or a related material. Such liquids are often comprised of generally linear-chain polymers; the physical properties (e.g. melting point and so on) of such materials may depend on the molecular weight of the polymers.

In some embodiments, such a silicone material may include, or be, a silicone resin. The terminology of a silicone “resin” is used herein to specifically refer to networks comprising Si—O units. In many embodiments such materials may be highly crosslinked to form a cage-like network of SiO₄ units (often referred to as Q units) and to additionally bear, e.g. at outer surfaces of the network, at least some silicon atoms bearing methyl groups. Such methyl-bearing silicon atoms are often referred to as M units in the case of three methyl groups, and as D or T units in the case of two or one methyl groups. Such silicone resins are commonly referred to in the trade as MQ resins (or, as MTQ resins, and so on, depending on the particular structure). Such resins, depending e.g. on their molecular weight, may be e.g. soluble or insoluble in various liquids and at various temperatures. Various such resins may be referred to e.g. as trimethylated silica, trimethyl siloxysilicate, silicic acid (trimethylsilyl ester), silicic acid (diethyoxyoctylsilyl trimethylsilyl ester) and so on. Any such silicone resin, of any suitable structure and composition, may be used. It will be appreciated that any such silicone resin, in order to be able to form a hydrophobic film, should comprise a sufficient number of nonpolar groups (e.g. methyl groups, whether in the form of M, D or T units), e.g. at the outer surfaces of the silicone network, to impart the desired hydrophobicity.

Silicone resins have been found to be particularly advantageous as film-forming materials in the present application. However, some such resins may not be liquid at room temperature. Accordingly, in some embodiments one or more silicone resins may be mixed with one or more silicone liquids (e.g. linear polydimethylsiloxane (PDMS) liquids) to form a film-forming mixture. In some embodiments (depending e.g. on the molecular weight of the silicone resin, its concentration in the silicone liquid, and so on), the silicone resin may become dissolved in the silicone liquid. However, this is not strictly necessary. That is, in some embodiments the silicone resin may merely need to be adequately wetted and suspended in the silicone liquid to an extent that allows the mixture of the two to be used as a film-forming material.

Thus, in some convenient embodiments, a film-forming material of a waxing composition (again, noting that the term waxing composition is used herein in accordance with the colloquial use of the term waxing and does not require the presence of a “wax” according to the strict chemical definition of such materials) may comprise a mixture of one or more silicone resins and one or more silicone (e.g. PDMS) liquids. The specific ratio at which the resins and liquids are used may depend e.g. on the molecular weight and structure of the resin, as will be well understood. It will be appreciated that even though some silicone liquids (comprised of e.g. linear PDMS) may not, if used alone, form a satisfactorily hard and durable protective film, such liquids may be advantageous for use in combination with silicone resins with which they can form a durable film. Such silicone liquids are typically non-volatile to the extent that they are expected to remain in the thus-formed protective film, for an extended period (e.g. for as long as the film itself lasts).

Silicone liquids, silicone resins, and blends of silicone liquids and silicone resin which may be suitable for use include for example: products available from Momentive under the trade designations YR 3370 M/T and SS 4230; products available from Dow under the trade designations DOWSIL 2405, DOWSIL MQ-1640, DOWSIL MQ-1600, DOWSIL 2-1912, DOWSIL RSN-0220, DOWSIL RSN-9118, AND DOWSIL 2-2078; products available from Shin-Etsu under the trade designations KR-480, KR-251, and KR-282; products available from Siltech under the trade designations SILMER Q25 AND SILMER Q30; and, products available from Wacker under the trade designations WACKER TPR, SILRES REN 80, BELSIL B110, AND SILRES 604. (Such products may be referred to by various vendors as, for example, silicone oils, silicone fluids, modified silicone resins, silicone waxes, silicone liquids, silicone mixtures and blends, and so on.) Various silicone materials (e.g. fluids, resins, and blends thereof) are described in detail in U.S. Pats. 7,541,323 and 7,378,382, both of which are incorporated by reference in their entirety herein. In various embodiments, any such silicone resin and silicone liquid may be combined to form a film-forming material upon which a waxing composition is based.

In some embodiments, at least one of the silicone liquids and/or silicone resins that are present, may comprise reactive groups that facilitate or assist in film formation. For example, a silicone resin (e.g. an MQ resin) may comprise an effective number of silanol groups that allow the silicone resin to form chemical bonds (such reactions are typically referred to as condensations). However, the present work has indicated that it is not strictly necessary for any such chemical reactions to occur in order to form a satisfactory hydrophobic protective film out of silicone resins and silicone liquids. (It is noted in passing that even a “nonfunctional” silicone resin such as e.g. an MQ resin, may still comprise some silanol groups; however, in a nonfunctional resin the groups are present at such a low concentration that little or no condensation may occur.)

Those of ordinary skill will be aware that materials such as silicone oils and silicone resins are often used as defoamers. The present approach, in which such materials are e.g. added to a sudsed washing composition in such manner as to avoid collapsing the suds, thus goes directly against many common uses of such materials.

If desired, any film-forming material that comprises a silicone oil and/or a silicone resin, may include additional film-forming ingredients, e.g. any of the waxes described herein.

In some embodiments, the waxing composition may comprise one or more constituents that are configured to chemically react with the surface that is to be washed/waxed. Such materials are optional, it having been found in the present work that reactive components are typically not needed when the surface to be washed/waxed is, for example, a clear-coat (e.g. of a vehicle) that is in good condition. However, it has been found that such reactive components can enhance the performance of the waxing composition when the composition is applied e.g. to a clear-coat that is oxidized or otherwise degraded or compromised. That is, in some embodiments such a reactive material may covalently bond to the surface so as to form a compatibilizing layer on the surface to which the film-forming material(s) can more easily adhere.

For example, a reactive silicone fluid may be present in the waxing composition, such as e.g. an amino-functional silicone (e.g. an amino-functional polydimethylsiloxane). Such a reactive silicone fluid may bond to the surface to provide a silicone-rich layer that, for example, a film-forming material comprising e.g. a silicone resin of the general type described above, can readily adhere to. Such a reactive silicone fluid, if present, may only need be present in an amount sufficient to adhere to e.g. areas of the surface that have been degraded. Thus in various embodiments, a reactive ingredient, e.g. a reactive silicone fluid, may be present in the waxing composition at a weight percent of at most 2.0, 1.5, 1.0, 0.8, or 0.6. In further embodiments, such a reactive ingredient may be present at a weight percent of at least 0.1, 0.2, 0.3, 0.4, or 0.5.

Although amino-functional silicones were mentioned above, any suitable functionality may be used, for example acrylo groups, epoxy groups, hydroxyl groups, mercapto groups, silane groups, and so on. Various reactive silicone materials which may be suitable for use include for example: products available from Momentive under the trade designation SEM-253; products available from Dow under the trade designations XIAMETER OFX-0531, XIAMETER OFX-0536, DOWSIL 2-8566, XIAMETER OFX-8468, and XIAMETER OFX-840; and products available from Siltech under the trade designations SILAMINE MUE, SILAMINE C50, and SILAMINE AS. Various reactive silicones and their use are discussed in detail in U.S. Pats. 6475934 and 8829092, which are incorporated by reference herein in their entirety for this purpose.

In some embodiments, one or more diluents may be present in the waxing composition. The term diluent is used herein to refer to a hydrophobic liquid that is not water-miscible to any significant extent (e.g., that is miscible with water to no more than 10, 5, 2, or 1.0 wt.% at 20° C.) and is distinguished from any other, water-miscible liquid that may be present as an additive in the waxing composition, as discussed later herein. Such a diluent may, for example, allow the viscosity of the waxing composition to be tailored to a desired range, may allow the waxing composition to be more easily spread onto a surface, and so on. Potentially suitable diluents include various organic liquids such as e.g. paraffinic hydrocarbon fluids (e.g. isoparaffinic hydrocarbon fluids) e.g. comprising approximately 13-14 carbon atoms; kerosines, mineral oils, and other hydrocarbon-based fluids, glycol ethers, and so on. Liquids which may be suitable for use include for example: products available from ExxonMobil under the trade designations ISOPAR L, G, M and EXXSOL D95; products available from Calumet under the trade designations DRAKESOL 205 AND DRAKESOL 165AT; products available from Chevron Phillips under the trade designation SOLTROL 142, products available from Dow under the trade designations HEXYL CELLOSOLVE, DOWANOL PPH, and DOWANOL DIPPH; the product available from Eastman Chemical under the trade designation EASTMAN OMNIA; and products available from Stepan Company under the trade designations STEPASOL MET-10U and HALLCOMID M-10.

A broad range of such liquids are available with a variety of vapor pressures, viscosities, and so on. In some embodiments, the liquids may be compatible, e.g. miscible, with some or all of the silicone materials that are present in the waxing composition as film-forming materials. However, this is not strictly necessary as long as the waxing composition can be disposed on a surface to form a suitable film. Thus in some embodiments at least one or more components of the film-forming material may be present in the form of parcels, particles, etc., that are e.g. suspended in the waxing composition.

In general, any liquid diluent may be used as long as it allows the herein-described functioning to be obtained. Potentially suitable liquids also include any of the well-known liquids classed under the general category of e.g. vegetable oils and nut oils. Such oils may include e.g. olive oil, palm oil, soybean oil, canola oil, peanut oil and so on. In some particular embodiments, any such liquid diluent may exhibit a sufficiently lower vapor pressure to exhibit a flash point above 60 degrees C, may include more than 12 carbon atoms, or may otherwise meet the requirements for the diluent to be classified as an “exempt” VOC under the criteria promulgated by the California Air Resources Board and the EPA.

As noted, the presence of any such diluent is not necessarily required in order to achieve the effects disclosed herein. However, in some embodiments some such diluents may enhance the ease of use of the waxing composition, as revealed by the following discussion.

Strictly speaking, it may not be necessary that a waxing composition must be present as a layer on top of the washing composition in order for the methods disclosed herein to be performed. That is, in some embodiments the waxing composition might be present as a layer below the bottom of the washing composition (e.g., as a layer on the floor of the container in which the washing/washing assemblage is held). In some embodiments, at least some portion of the waxing composition may be present as non-stabilized parcels (e.g. droplets or globules) that are e.g. randomly distributed throughout at least a portion of the washing composition (e.g. in the manner of the oil in a so-called LAVA LAMP). Such arrangements may be adequate as long as the washing implement can be immersed into the washing composition and e.g. swished around so that the implement contacts the waxing composition, wherever it may be located, to a sufficient extent that the waxing composition is imbibed onto the washing implement.

However, it has been found that providing the waxing composition as a layer on top of the top surface of the washing composition (e.g. between the top of the washing composition and the bottom of any suds layer present thereon) seems to enable a particularly convenient mode of use. Accordingly, in some embodiments it may be desirable to configure the waxing composition to promote the formation of such a top layer. For example, a purely silicone-based waxing composition (e.g. a blend of silicone liquid and silicone resin) may solidify to form an excellent protective film. However, the present investigations have found that a purely silicone-based waxing composition (or one with a sufficiently high level of silicone) may sink to the bottom of an aqueous washing composition due to it having an overall density (in some cases, approximately 1.02 g/cc) that is higher than that of the aqueous washing composition. Such a tendency can be circumvented by configuring the waxing composition (e.g. by including a sufficient quantity of a suitable low-density hydrophobic diluent) to have a density that is less than that of water. Accordingly, a suitable amount of hydrophobic organic liquid (many of which may advantageously exhibit a density of 0.80 g/cc or less) may be included in the waxing composition to lower the overall density of the waxing composition below the density of water. This will cause the waxing composition to tend to float to the top of the aqueous washing composition and form a layer thereon. Thus in various embodiments, an organic liquid diluent (e.g. with a density of less than 0.95, 0.90, 0.85, or 0.80) may be present in the waxing composition e.g. at a weight percent of at least 10, 20, 30, 40 or 50 wt.%. In further embodiments, such an organic liquid diluent may be present at a weight percent of at most 60, 55, 45, 35, 25, 15, or 5%.

In various embodiments, a thus-formed waxing composition may exhibit a density of less than 1.00, 0.95, 0.92, 0.90, or 0.88 g/cc. In further embodiments, the density of the waxing composition may be at least 0.80, 0.83, or 0.86 g/cc. In various embodiments, a thus-formed waxing composition may exhibit a density that is less than the density of the washing composition with which it is used, 0.02, 0.04, 0.08, 0.10, or 0.12 g/cc.

The providing of a waxing composition that is purposefully configured to have a density that is lower than the density of an aqueous washing composition with which the waxing composition is used, in order to promote the ability of the waxing composition to float to the surface of the washing composition to form and maintain a layer thereon, is thus another aspect of some embodiments of the present disclosure.

In some embodiments, one or more water-miscible liquid additives may optionally be present in the waxing composition. The presence of such a water-miscible additive may, in some cases, enhance the ability of the waxing composition to spread evenly on a washing implement. Such a water-miscible liquid additive will be miscible with water at 20° C. to a significant extent (e.g. greater than 10 or even 20 wt.% (additive weight/water weight)) and will be distinguished from a water-immiscible liquid diluent as described previously herein. In some embodiments the water-miscible liquid additive will be sufficiently hydrophobic to be miscible with the other components of the waxing composition, e.g. so that the waxing composition is present as a single phase. In other words, such a liquid additive may have an intermediate hydrophobic/hydrophilic nature so that it is miscible with water but is also miscible with various hydrophobic components of the waxing composition. In many embodiments, such a water-miscible additive may be an organic liquid that includes one or more polar atoms or groups (e.g. oxygen atoms, hydroxyl groups, carbonyl groups, ester groups, nitrogen atoms, and so on) to impart intermediate overall polarity. In some embodiments, such a water-miscible additive may be a water-miscible organic alcohol. Other materials that may be suitable include various water-miscible glycols, glycol ethers, esters, ketones, and so on. Particular materials which may be suitable for use include for example substances such as ethanol, isopropanol, decanol, acetone, methyl acetate, and ethyl acetate, and products available from Dow under the trade designations BUTYL CELLOSOLVE, BUTYL CARBITOL, DOWANOL EPH, CARBITOL, PROPYL CELLOSOLVE, and HEXYL CARBITOL.

It will be appreciated that at least a portion of any such water-miscible additive that is present in the waxing composition as initially combined with to the washing composition to form a washing/waxing assemblage, may eventually be leached out of the waxing composition into the washing composition. However, it is likely that if this happens, it will occur gradually, e.g. over several minutes or more. All references herein to the amount of waxing composition that is disposed e.g. as a surface layer atop the washing composition, the amount of water-miscible liquid additive that is present in the waxing composition, the ratios of various components of the waxing composition, and so on, are understood to be with respect to the waxing composition as initially formulated and initially combined with the washing composition to make a washing/waxing assemblage.

In various embodiments, a water-miscible liquid additive may be present in the waxing composition e.g. at a weight percent of at least 0.5, 1.0, 2.0, 4.0, 7.0, or 10 wt.%. In further embodiments, such an additive may be present at a weight percent of at most 80, 60, 40, 20, 15, 12 8.0, 6.0, 3.0, 1.5, 0.8, 0.4, or 0.2. The amount and identity of any such water-miscible liquid additive(s) will be chosen so that the waxing composition as a whole is hydrophobic and immiscible with water (even though at least some portion of the water-miscible liquid additive may be gradually leached out into the water, as noted above). In some embodiments, essentially no such additive may be present in the waxing composition as formulated (this is defined as meaning that less than 0.1 % of any such additive is detectable.) It will be appreciated that any such water-miscible liquid additive, if it has a low density, can augment the above-discussed lowering of the overall density of the waxing composition that may be desirable in some instances. For example, many organic alcohols and similar compounds have a density of under 0.80 g/cc, and thus may serve this purpose.

Any other ingredient(s) may be present in the waxing composition, for any purpose as desired. Such an ingredient might be e.g. a biocide, preservative, UV-stabilizer, antioxidant, fragrance, dyes and colorants, and so on. (Any such dye or colorant will be for the purpose of imparting a color to the waxing composition itself and typically will not be visible in the resulting protective film.) Various materials that may be suitable for use in a waxing composition as disclosed herein are described (although not for the specific purposes and arrangements disclosed herein) in U.S. Pats. 6475934 and 6506715, and 7541323, which are incorporated by reference herein in their entirety for this purpose.

In various embodiments, exemplary waxing compositions may comprise a film-forming material present at from 15, 20, 25, or 30, to 35, 40, 50, 60, or 70 wt.% of the waxing composition. In some embodiments, such a film-forming material may comprise a combination of silicone liquids and silicone resins as noted. In some embodiments, a waxing composition may further comprise a reactive silicone material, e.g. an amino-functional silicone material as previously described, present at from 0.1 to 1.0 wt.% of the waxing composition. In some embodiments, such a waxing composition may also comprise a liquid diluent, present at a weight ratio of from 10, 20, 30, 40 or 50, to at most 70, 65, 60, 55, 50, or 45 wt.%. In some embodiments, such a waxing composition may also comprise a water-miscible liquid additive, present at from 4, 8, or 12, to 25, 20, 15, or 13 wt.%. In some embodiments, a waxing composition may consist essentially of, or consist of, any of the above-listed combinations.

In some embodiments, one or more substances may be held below a specified level, or excluded from, the waxing composition. Thus in some embodiments, the waxing composition comprises less than 0.5, 0.2, 0.1, 0.05, or 0.01 wt.%, in total, of any cationic surfactant(s). In some embodiments, the waxing composition comprises less than 0.5, 0.2, 0.1, 0.05, or 0.01 wt.%, in total, of any surfactant of any kind (e.g. nonionic, anionic, cationic, and so on.) In some embodiments, the waxing composition comprises less than 1.0, 0.5, 0.2, 0.1, 0.05, or 0.01 wt.% of hexamethyldisiloxane. In some embodiments, the waxing composition comprises less than 5, 2, 1.0, 0.5, 0.2, 0.1, 0.05, or 0.01 wt.% of any polymer that serves as a thickener, e.g. an acrylic-based polymer of the general type described in U.S. Pat. 7541323, which is incorporated by reference in its entirety herein. In some embodiments, the waxing composition comprises less than 5, 2, 1.0, 0.5, 0.2, 0.1, 0.05, or 0.01 wt.% of any acrylic resin of any type. In some embodiments, the waxing composition as formulated (e.g. before being combined with a washing composition to form a washing/waxing assemblage) comprises less than 10, 5, 2, 1.0, 0.2, or 0.1 wt.% of water.

### Washing Composition

A waxing composition as disclosed herein is configured for use in combination with a washing composition. In many convenient embodiments, such a washing composition may be obtained by adding a washing concentrate to water, thus diluting the washing concentrate to obtain a washing composition having a desired concentration of active ingredients.

A washing concentrate, and the resulting washing composition, will include at least one surfactant. The present work has found that, in general, a waxing composition as disclosed herein can achieve the desired effects when used in combination with any category of surfactant. Thus in some embodiments, an end user may use the waxing composition in combination with whatever surfactant is present in a washing concentrate of the user’s choice. Thus, a washing concentrate/composition as used with the waxing composition may be chosen from any suitable category of surfactants, e.g. nonionic or ionic (e.g. cationic, anionic, amphoteric, or zwitterionic). In some embodiments, a single surfactant may be used. In some embodiments, multiple (e.g. two, three, four or more) surfactants may be used in combination; such surfactants may be all of the same category (e.g. they all may be nonionic) or they may be chosen from different categories.

Suitable nonionic surfactants that may be used include polyoxyethylene sorbitan fatty acid esters, polyoxyethylene sorbitol fatty acid esters and related compounds, alkyl polyglucosides and related compounds, and lauryldimethylamine oxide, myristamine oxide, polyethylene oxide lauryl ether, and related compounds. Suitable anionic surfactants that may be used include e.g. sodium lauryl sulfate, sodium laureth sulfate, and related compounds, alkyl benzene sulfonate, alpha olefin sulfonate and related compounds, and sodium dodecylbenzene sulfonate and related compounds. Suitable zwitterionic surfactants include e.g. fatty acid amide type surfactants such as cocamidopropyl betaine, cocamide diethanolamine, and related compounds.

Nonionic surfactants which may be suitable for use include for example: products available from Dow under the trade designations TERGITOL 15-S-9 AND ECOSURF EH-6; the product available from Huntsman under the trade designation SURFONIC L24-7; the product available from Evonik under the trade designation TOMODOL 900; the product available from Croda under the trade designation TWEEN 80; the product available from Millipore Sigma under the trade designation SPAN 80; the product available from BASF under the trade designation LUTENSOL XP60; the product available from BASF under the trade designation GLUCOPON 425N, the product available from Dow under the trade designation CG-425; and, the product available from Stepan under the trade designation BIOSOFT N1.

Anionic surfactants which may be suitable for use include for example: the products available from Stepan under the trade designations WA-EXTRA, STEOL CS-230, STEOL CS-270, BIOTERGE AS-40, MAPROSYL 30B, and BIOTERGE D-40; the products available from Pilot under the trade designations CALFOAM SLS-30, CALFOAM ES-702 and ES-302, CALSOFT AOS-40, CALSOFT LAS-99, the products available from BASF under the trade designations STANDAPOL ES-2 and STANDAPOL ES-3, and the product available from Clariant under the trade designation HOSTAPUR SAS-60.

Zwitterionic surfactants which may be useful for use include for example: the products available form Stepan under the trade designations AMPHOSOL CG and AMMONYX DO, LO, LMDO and MO; the products available from Pilot under the trade designations CALTAINE C-35 and CALAMIDE C; and, the product available from Evonik under the trade designation TEGOTENS DO.

Those of ordinary skill will appreciate that these are only some of the numerous surfactants that are potentially suitable for use. Descriptions of potentially useful surfactants of various categories (e.g. nonionic, anionic and zwitterionic) can be found e.g. in U.S. Pat. 6506715, which is incorporated by reference in its entirety herein for this purpose.

While, as noted above, the effects disclosed herein may be achieved by using a waxing composition in combination with any category of surfactant, the present work has found that enhanced performance may be obtained when using nonionic surfactants. In some embodiments, one or more nonionic surfactants may be used in combination with one or more anionic surfactants. (Such a combination may not necessarily enhance the effectiveness of the waxing composition e.g. in imparting water-beading; however, such a combination may have other attributes, e.g. enhancing the “feel” or texture of the washing composition, without detracting from the performance of the waxing composition.) In such embodiments, the weight ratio of nonionic surfactant to anionic surfactant in the washing concentrate and in the resulting washing composition may be at least 1.0, 1.5, 2.0, 2.5, or 3.0. In further embodiments, the weight ratio may be at most 6.0, 5.0, 4.0, or 3.0. In various embodiments, the washing concentrate may comprise from e.g. 1.0, 2.0, 3.0, 4.0, or 5.0, to 15, 10, 9.0, 8.0, 7.0, or 6.0 wt.% nonionic surfactant. In various embodiments, the washing concentrate may comprise from e.g. 0.1, 0.5, 1.0, or 1.5, to 5.0, 4.0, 3.0, 2.0, or 1.7 wt.% anionic surfactant. After being diluted into water at a suitable dilution ratio (as discussed below) to form a washing composition, the nonionic and/or anionic surfactant(s) will be present at a wt.% dictated by their concentration in the washing concentrate in combination with the particular dilution ratio that is used.

Although one or more cationic surfactants may be present in some embodiments, it has been found that, as noted above, nonionic surfactants, anionic surfactants, and combinations thereof, may provide enhanced performance. While not wishing to be limited by theory or mechanism, it may be that at least some cationic surfactants are able to “wet out” or otherwise deposit on a surface (that is to be cleaned), in a manner that may compete with the ability of the hydrophobic, film-forming material of the waxing composition to wet out on the surface so as to form a film thereon. Thus in various embodiments, a washing concentrate as disclosed herein may comprise less than 2.0, 1.0, 0.5, 0.2, 0.1, 0.05, 0.01, or 0.005 wt.% of (total) cationic surfactant. Correspondingly, a washing composition as achieved by diluting the washing concentrate with water may comprise less than 1.0, 0.5, 0.2, 0.1, 0.05, 0.01, 0.005, 0.001, or 0.0001 wt.% of (total) cationic surfactant.

Based on the disclosures herein, ordinary artisans will appreciate that in some embodiments, it may be advantageous to choose a surfactant or surfactant combination that interacts with a particular waxing composition that is used, only in a weak manner. That is, it may be advantageous to choose surfactants that do not easily form the ingredients of the waxing composition into a stable emulsion. For example, ordinary artisans will appreciate that a silicone-containing surfactant may exhibit a greater ability to form a silicone liquid into a stable emulsion, than a surfactant that does not contain silicone. Thus, in embodiments in which the hydrophobic film-forming components of the waxing composition include silicone materials (e.g. silicone liquids and/or silicone resins), it may be advantageous to use a surfactant or surfactants that stay below a threshold level of silicone content. Thus, if a waxing composition comprises a silicone liquid and/or a silicone resin, it may be advantageous to use a surfactant or surfactants that comprise e.g. less than 40, 30, 20, 10, 5, 2, 1.0, 0.5, or 0.1 wt.% silicone units (of any type, in total).

From the disclosures herein it will be appreciated that in some embodiments it may be helpful to choose surfactants and waxing compositions that interact only weakly or minimally, and/or to combine the waxing composition with a washing concentrate (that includes surfactant) to form a washing/waxing assemblage in a manner that minimizes agitation, high-shear mixing, and so on. Either or both of these general approaches may be helpful in providing that in a washing/waxing assemblage, the waxing composition remains largely as a non-stabilized phase rather than e.g. forming a stable dispersion or emulsion. However, it is emphasized that these are general guidelines rather than strict requirements under all conditions. Thus for example, if a surfactant (of a washing concentrate) and a waxing composition interact only weakly, it may be possible to combine these components somewhat aggressively without them forming a stable dispersion or emulsion (rather, they may simply separate back out into readily apparent macroscopic phases). Conversely, if a waxing composition is combined with a washing concentrate (and water) to form a washing/waxing assemblage in a very gentle, low-shear manner (e.g. by being manually poured in), it may not be required that the surfactant (of the washing concentrate) and the waxing composition are only able to interact in a very weak manner. Furthermore, as discussed earlier herein, in many embodiments it may be acceptable for a portion (e.g. up to 10, 20, or even 30 wt.% or more) of the waxing composition to be diverted into a stable dispersion or emulsion, as long as a majority of the waxing composition remains as a non-stabilized phase. It will be appreciated that some surfactant may e.g. weakly associate with a non-stabilized parcel of waxing composition 20 (e.g. a macroscopic parcel such as a layer 21 of waxing composition). However, based on the disclosures herein it will be understood that such an interaction will not be sufficient to cause the parcel of waxing composition to be considered to be a stable emulsion.

A washing concentrate may be diluted into water at any desired ratio to form a washing composition with a surfactant or combination of surfactants that is present in the washing composition at a desired wt.%. In various embodiments, a washing concentrate may be configured to be added to water at a weight ratio of at least 1:250, 1:200, or 1:150. In further embodiments, a washing concentrate may be configured to be added to water at a weight ratio of at most 1:25, 1:50, 1:75, or 1:100. In various embodiments a washing concentrate may be configured to comprise a total surfactant concentration of at least 2, 4, 6, 8 or 10 wt.%. In further embodiments, the washing concentrate may be configured to comprise a total surfactant concentration of at most 15, 12, 11, 9, 7, or 5 wt.%.

A resulting washing composition may comprise a surfactant or combination of surfactants (e.g. a nonionic surfactant or a combination of nonionic and anionic surfactants) that is present in the washing composition at a weight percent (of total surfactant to the total weight of the washing composition, including water) of at least 0.01, 0.02, 0.03, or 0.04. In further embodiments, the weight ratio of total surfactant to total washing composition may be at most 0.15, 0.10, 0.08, 0.06, or 0.05. By way of a specific example, a washing concentrate that contains 5 weight percent of a surfactant, when diluted in water at 1 oz. concentrate to 1 gallon water (a dilution ratio of 1:128) will result in a washing composition with the surfactant present at 0.04 weight percent.

A washing concentrate may include any other ingredients for any desired purpose. Such ingredients may include e.g. thickening additives (e.g., carboxymethylcellulose, polyvinylpyrrolidone, xanthan gum, carrageenan, and so on), opacifying additives and/or dyes and colorants, UV-stabilizers, UV-absorbers and the like, fragrances, biocides, preservatives, and so on. Any such ingredient may be present in the washing concentrate at a level chosen to provide the desired level of the ingredients in the final washing composition. In some embodiments, a washing concentrate may include a desired level (e.g. from 1, 2, 3, up to 10, 8, or 5 wt.%) of salt, e.g. NaCl. Such an additive may enhance the hand feel of the resulting washing composition. Also, such an additive (depending on the concentration) may increase the density of the washing composition at least slightly. This which may be beneficial in some instances; for example, it can help ensure that a silicone-based waxing composition (i.e., a waxing composition in which the hydrophobic film-forming material comprises at least 50 wt.% of silicone units) will exhibit a lower density than the washing composition. In some embodiments, water (e.g. present at up to 40, 60, 80, or even 90 wt.%) may be present in the washing concentrate, e.g. to provide that the concentrate is handleable as a flowable liquid mixture.

Various materials that may be suitable for use in a washing concentrate and/or in a waxing composition as disclosed herein, are discussed in detail in U.S. Pat. 8349062, which is incorporated by reference herein in its entirety for this purpose. In various embodiments a washing concentrate may be packaged in individual containers of a suitably chosen capacity, or in a bulk container from which a desired amount may be dispensed. In some embodiments a washing concentrate may be packaged in a water-soluble pouch or sachet.

As noted, in some instances a waxing composition may be supplied to an end user for use with a washing concentrate of the user’s choice. In such embodiments, the waxing composition may be packaged in any of the arrangements discussed previously herein. In some instances, a waxing composition may be supplied to an end user along with a washing concentrate that has been found to provide enhanced performance when used in combination with the waxing composition. In some such embodiments, the waxing composition and the washing concentrate may be packaged together, e.g. as a kit, but in separate containers within the kit (or in separate compartments or chambers of a common container), so that the waxing composition and the washing concentrate are not in direct, intimate contact with each other.

In some embodiments such a kit may be a starter kit that includes a washing implement (e.g. a two-sided hydrophobic/hydrophilic mitt of the type described earlier); such a starter kit may also include a suitably-sized bucket if desired. Replacement kits may be provided which only comprise the waxing composition and the washing concentrate.

The compositions and/or methods disclosed herein may be used for the manually performed, concurrent washing/waxing of any desired surface. One common application for such arrangements will be the washing of motor vehicles (e.g. cars, trucks, recreational vehicles, and so on). However, this use is not limited to motor vehicles and may encompass e.g. non-motorized campers and so on. Nor is it limited to wheeled vehicles, but rather embraces e.g. motorized boats, sailboats, snowmobiles, aircraft, and so on. In fact, in some embodiments the arrangements disclosed herein may be useful for concurrent washing/waxing of surfaces of immobile or seldom-moved items and structures, e.g. mobile homes, modular housing, signage, panels or walls of buildings, and so on. In some particular embodiments, the compositions and methods disclosed herein may be used for the concurrent washing/waxing of surfaces that bear an outermost layer of so-called “clearcoat”. Such layers are often found on vehicles, which typically bear a base coat that provides color and optical effects (e.g. a metallic or pearlescent appearance) and a clearcoat that provides physical protection, UV protection, and so on. Many such clearcoats are, for example, acrylic polyurethanes or similar materials. The arrangements disclosed herein are well-suited for concurrent washing/waxing of such surfaces.

### EXAMPLES

### Working Examples

The hood of a Toyota Yaris (with approximately 40000 odometer miles, with the sheet metal, color layer and clearcoat in good condition), in the absence of any pre-existing coatings of hydrophobic film-forming material (whether silicone, wax, etc.) was divided (by white tape) into three sections. Water was sprayed onto each section using a garden hose to confirm that each section initially demonstrated water-sheeting behavior (rather than water-beading behavior).

Three buckets of wash mixture were prepared and used to wash the different sections of the hood. One bucket (Comparative Example; “CE”) contained 2 gallons of water and 2 ounces (i.e., at a dilution ratio of 1:128) of a commercially available washing concentrate (Meguiar’s Ultimate Wash and Wax). The aqueous wash mixture was sudsed by adding water to bring the total up to approximately 2 gallons by way of a garden hose with nozzle on “shower” setting, to roil and froth the water. The wash mixture exhibited significant suds/foam atop the water.

Two other buckets were similarly prepared. To one bucket of sudsed mixture was added 15 grams of waxing composition (Working Example WE-1). To another bucket of sudsed mixture was added 30 grams of waxing composition (Working Example WE-2). The waxing compositions were added by pouring the waxing composition into the bucket, down through the suds layer, to reach the aqueous wash mixture.

Each waxing composition was of the general formula: 35 wt.% of a representative hydrophobic, silicone-based film-forming material (Dowsil 2-1912); 0.5 wt.% of a representative amino-functional silicone (Xiameter OFX-8468); 51.5 wt.% of a representative hydrophobic diluent (ISOPAR M); and 13 wt.% of a representative water-miscible liquid additive (isopropanol).

The three sections of the Yaris hood were washed with a washing implement (a microfiber mitt of the type available from Meguiar’s under the trade designation X3002 Microfiber Wash Mitt (Super-Thick Reusable). Different mitts were used for each of the three buckets/hood sections. In each case, the mitt was inserted downward through the suds layer into the aqueous wash mixture and was gently swished around. The mitt was then removed upward and excess water was allowed to drain back into the bucket for a short time, after which the mitt was contacted with the hood section and gently moved around the hood section. Each hood section was then rinsed with water from a garden hose. As shown in FIG. 6, the leftmost, Comparative Example section (labeled CE), exhibited water-sheeting behavior that was similar to that exhibited before being washed. In sharp contrast, Working Example sections WE-1 and WE-2 exhibited clearly visible water-beading immediately upon being rinsed with water, as evident in FIG. 6.

Two more buckets of wash mixture were prepared. Each bucket contained 3 gallons of water and approximately 3 ounces of a commercially available washing concentrate (Meguiar’s Deep Crystal Wash). The aqueous wash mixture was sudsed by adding water to bring the total up to approximately 3 gallons by way of a garden hose with nozzle on “shower” setting, to roil and froth the water. Both wash mixtures exhibited significant suds/foam atop the water.

To one bucket of sudsed mixture (Working Example WE-3) was added 7.5 grams of a waxing composition of similar composition to those of Working Examples WE-1 and WE-2. To another bucket of sudsed mixture (Working Example WE-4) was added 12 grams of the waxing composition. The waxing compositions were added by pouring the waxing composition into the bucket, down through the suds layer, to reach the aqueous wash mixture. Two washing/waxing assemblages (WE-3 and WE-4) were thus generated.

An automobile that had not been washed for at least one month was obtained. The automobile exhibited the usual level of dust, etc., characteristic of having been exposed to the environment and driving conditions in Southern California for at least one month. The sheet metal, color layer and clearcoat of the automobile were in good condition. The automobile was rinsed with water from a garden hose to remove excess dirt and debris. (No particular effort was made to remove any residual remnants of pre-existing coatings of hydrophobic film-forming material; however, it appeared that little if any such coatings were present.) The water-rinsing revealed that most of the surfaces of the metal panels of the automobile exhibited water-sheeting behavior, with a few small portions exhibiting slight water-beading.

The automobile was divided into left and right sections, one of which was washed with WE-3, the other with WE-4. Separate Microfiber Wash Mitts were used for each bucket/section. Each section was washed, panel by panel, in a normal manner. The wash mitts were returned to the bucket to replenish the washing/waxing assemblage on the mitt, as needed. The sections were rinsed with water shortly after being washed.

After washing, both sections of the car appeared clean and exhibited excellent water beading, in notable contrast to their initial condition. There was no obvious difference between the results obtained with WE-3 and WE-4.

### Illustrative Examples

An 800 cc beaker was obtained. The beaker was clear (glass) so that the contents therein could be observed. The beaker was filled with water. For this illustrative experiment, wash concentrate was not added so that the water would not be obscured by suds. A waxing composition of the general type used in Working Examples WE-1 and WE-2 was prepared. A yellow dye was added to the waxing composition to enable the waxing composition to be more easily seen. The waxing composition was then poured into the water-filled beaker. The waxing composition gathered into a thin layer atop the top surface of the water, as was clearly evident by visual inspection. A piece of hydrophobic microfiber cloth (representative of a hydrophobic microfiber washing mitt) was immersed into the water and was then removed therefrom, passing through the surface layer of waxing composition in the process. It was evident that a significant portion of the waxing composition migrated onto the microfiber material during this process, as evidenced by the yellow color spreading over much of the microfiber cloth. A second immersion/removal resulted in still more of the waxing composition being imbibed onto the microfiber cloth. These results thus indicated that 1) a waxing composition can be added to water so as to form a surface layer, and 2) immersing a washing implement into the water, passing the implement through the surface layer of waxing composition in the process, can cause a significant amount of the waxing composition to be imbibed onto the washing implement.

Other experiments were performed to illustrate further aspects of the discoveries disclosed herein. For example, some experiments were done in which a waxing composition and a washing concentrate were added to a common bottle (at a 1:1 weight ratio), and were mixed by manual shaking. The waxing composition was of the type described for Working Examples WE-1 and WE-2; the washing concentrate comprised a representative nonionic surfactant (present at approximately 5.0 wt.%) and a representative anionic surfactant (present at approximately 1.5 wt.%), and various biocides, thickeners, colorants, fragrances, etc. (the concentrate was approximately 87 wt.% water). The surfactants did not contain silicone.

The bottle was then allowed to sit for a short period of time (a few minutes), after which the waxing composition and the washing concentrate were observed to largely reform into two separate phases (easily visible because of colorant in the washing concentrate). These results indicated that in at least some instances, at least some mixing of some waxing compositions and washing concentrates can be tolerated without, for example, the waxing composition becoming stably emulsified by the surfactant(s) of the washing concentrate.

Similar experiments were done in which a mixture of this washing composition and this washing concentrate, immediately after being shaken/mixed as described above, was poured into a bucket. The bucket was then filled with water with a garden hose with the nozzle on “shower” setting. This caused mild agitation/frothing of the mixture during the process. The resulting washing/waxing assemblage exhibited suds that were not as robust as those obtained by adding the same waxing concentrate to a presudsed washing composition prepared from the same washing concentrate. However, considerable sudsing was still observed; and, when the washing/waxing assemblage was used to wash test panels, the panels exhibited good water-beading. These results thus illustrated that (as discussed earlier herein) enhanced performance may be obtained by adding waxing concentrate to a presudsed washing composition with minimal agitation/mixing. However, these results also reveal that for at least some combinations of washing concentrate and waxing composition, the materials may be mixed with each other, and/or a washing/waxing assemblage may be at least mildly agitated, without rendering the materials unable to perform satisfactorily.

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary embodiments, elements, structures, features, details, arrangements, configurations, etc., that are disclosed herein can be modified and/or combined in numerous ways. It is emphasized that any embodiment disclosed herein may be used in combination with any other embodiment or embodiments disclosed herein, as long as the embodiments are compatible. For example, the methods disclosed herein may be used with a waxing composition, and a washing concentrate, of any of the arrangements, compositional features, and so on, disclosed herein. While a number of exemplary combinations are presented herein, it is emphasized that all such combinations are envisioned and are only prohibited in the specific instance of a combination that is incompatible.

In summary, numerous variations and combinations are contemplated as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein but to which no priority is claimed, this specification as written will control.

What is claimed is:

1. A method of concurrently washing and waxing a surface, the method comprising manually contacting a washing implement with the surface and moving the washing implement about the surface;
wherein the washing implement bears a first, washing composition that is present as a first, aqueous phase and that is an aqueous washing composition comprising at least one surfactant; and
wherein the washing implement bears a second, waxing composition at least a majority of which is present in a second, hydrophobic phase that is different from the first phase and that is a non-stabilized phase, and wherein the second, waxing composition is a hydrophobic, film-forming composition comprising at least one hydrophobic, film-forming material.

2. The method of claim 1 wherein the first, aqueous washing composition and the second, hydrophobic waxing composition are disposed on the washing implement by inserting the washing implement into a container comprising the first, aqueous washing composition as a first, aqueous phase and comprising the second, hydrophobic waxing composition as a second, hydrophobic phase, at least a majority of the second, hydrophobic phase being present as a layer atop the first, aqueous phase, so that at least some of the first, aqueous washing composition is deposited onto the washing implement as the washing implement is immersed in the first, aqueous washing composition and so that at least some of the second, hydrophobic waxing composition is deposited onto the washing implement as the washing implement passes through the layer of the second, hydrophobic waxing composition.

3. The method of claim 2 wherein the method comprises disposing a washing concentrate comprising the at least one surfactant in the container and disposing water into the container and mixing the washing concentrate and the water in the container to form the first, aqueous washing composition; and, wherein the method comprises adding the second, hydrophobic waxing composition to the container holding the first, aqueous washing composition, so that at least 50% by weight of the added waxing composition is formed into the layer of the second, hydrophobic waxing composition atop the first, aqueous washing composition.

4. The method of claim 3 wherein the washing concentrate and the water are mixed in the container so that the first, aqueous washing composition is a sudsed composition bearing visible suds above the surface of the first, aqueous washing composition, and wherein the second, hydrophobic waxing composition is added to the container holding the sudsed first, aqueous washing composition manually, without high-shear mixing, so that at least 80% by weight of the second, hydrophobic waxing composition is formed into the layer atop the first, aqueous washing composition rather than being stably emulsified with, or stably dispersed into, the first, aqueous washing composition.

5. The method of claim 3 wherein the washing concentrate and the water are disposed in the container and mixed, at a weight ratio of washing concentrate to water of from 1:20 to 1:200.

6. The method of claim 3 wherein the second, hydrophobic waxing composition is added to the container in an amount to provide a weight ratio of the second, hydrophobic waxing composition to the first, aqueous washing composition of from 0.04% to 0.6%.

7. The method of claim 1 wherein the washing implement comprises hydrophobic microfibers.

8. The method of claim 7 wherein the washing implement is a two-sided washing implement comprising a first major hydrophobic side comprising fibers, at least 90% of which are hydrophobic, and comprising a second major hydrophilic side comprising fibers, at least 20% of which are hydrophilic.

9. The method of claim 1 wherein the second, hydrophobic waxing composition and the first, aqueous washing composition are configured so that the second, hydrophobic waxing composition exhibits a density that is less than the density of the first, aqueous washing composition, by at least 0.04 grams per cc.

10. The method of claim 1 wherein the first, washing composition comprises at least one nonionic surfactant that is present in the first, washing composition at from 0.01 wt.% to 0.10 wt.%.

11. The method of claim 10 wherein the first, washing composition further comprises at least one anionic surfactant that is present in the first, washing composition at from 0.005 wt.% to 0.050 wt.%.

12. The method of claim 11 wherein the weight ratio of nonionic surfactant to anionic surfactant in the first, washing composition is from 1.0 to 5.0.

13. The method of claim 1 wherein the first, washing composition comprises less than 0.01 wt.% of cationic surfactant.

14. The method of claim 1 wherein the second, hydrophobic waxing composition comprises a hydrophobic film-forming material including at least one silicone liquid comprising a linear, nonreactive polydimethylsiloxane polymer; and, including at least one silicone resin, wherein the at least one silicone liquid and the at least one silicone resin are present in the second, waxing composition at a total weight percent of from 10 to 60.

15. The method of claim 14 wherein the at least one silicone resin comprises a network of Si—O units, at least some of which are SiO₄ (Q) groups and at least some of which are SiCH₃ (M) groups.

16. The method of claim 14 wherein the second, waxing composition comprises a reactive polydimethylsiloxane polymer that is present in the second, hydrophobic waxing composition at a weight percent from 0.1 to 2.0.

17. (canceled)

18. The method of claim 1 wherein the second, waxing composition comprise a hydrophobic diluent liquid that is present in the second, hydrophobic waxing composition at a weight percent of from 30 to 80.

19. (canceled)

20. The method of claim 1 wherein the second, hydrophobic waxing composition comprises a water-miscible liquid additive chosen from alcohols, glycol ethers and mixtures thereof, which water-miscible liquid additive is at least initially present in the second, waxing composition at a weight percent of from 2 to 80.

21. The method of claim 1 wherein the surface is a surface of a motorized or non-motorized vehicle.

22. A kit of items for concurrently washing and waxing a surface, the kit comprising:
a washing concentrate comprising at least one surfactant; and,
a waxing composition comprising at least one hydrophobic, film-forming material;
wherein the washing concentrate and the waxing composition are packaged separately within the kit so that the washing concentrate and the waxing composition are not in direct contact with each other,
and wherein the washing concentrate and the waxing composition are configured to be added into a single, common container along with a suitable quantity of water into which the washing concentrate is diluted, to form a washing/waxing assemblage that is usable for concurrent washing and waxing.

23-24. (canceled)
